(19) United States
(12) Patent Application Publication
(10) Pub. No.: US 2024/0368938 A1
(43) Pub. Date: Nov. 7, 2024

(54) HORIZONTAL ADJUSTMENT DEVICE FOR CURTAIN AND ELECTRIC CURTAIN

(71) Applicant: JEFF WH LI, IRVINE, CA (US)

(72) Inventor: JEFF WH LI, IRVINE, CA (US)

(21) Appl. No.: 18/143,253

(22) Filed: May 4, 2023

(51) Int. Cl. E06B 9/42; E06B 9/72

(52) U.S. Cl. CPC E06B 9/42; E06B 9/72

(57) ABSTRACT

A horizontal adjustment device for a curtain includes a reel bracket and an installation bracket detachably connected to a wall. The reel bracket is disposed on a side of the installation bracket away from the wall through the guiding and sliding mechanism. A bottom of the installation bracket is provided with a first limiting plate. A bottom of the reel bracket is provided with an adjustment plate. The first limiting plate is connected to the adjustment plate through a detachable connecting member. The first limiting plate has an adjustment through hole. An adjustment stud is arranged in the adjustment through hole. A top of the adjustment stud has a positioning top block. A positioning hole corresponding to the positioning top block is provided on the adjustment plate. A side of the reel bracket has a fixed installation piece for the reel to be installed.

### FIELD OF THE DISCLOSURE

The present disclosure relates to the technical field of the curtain adjustment technology, and more particularly to a horizontal adjustment device for a curtain and an electric curtain.

### BACKGROUND OF THE DISCLOSURE

The traditional electric roller blind is a motorized roller blind mechanism powered by a tubular motor, and it needs only to switch the power switch to operate, which is easy to operate and works quietly and smoothly. Therefore, it becomes an upgraded product of the manual roller blind. In the installation process of the existing electric roller blinds, there is no device for adjusting the horizontal level of the reel, so once the curtain box or the installation bracket is not installed horizontally resulting in the left and right ends of the roll tube not being at the same level, the curtain box or the installation bracket needs to be disassembled again for adjustment. Otherwise, the curtain fabric will be unevenly retracted on the curtain rod, and the curtain fabric will move to the lower end of the curtain rod, resulting in the phenomenon of curtain wrinkles or incomplete shading (as shown in FIG. 6 of the specification). Therefore, a curtain horizontal adjustment device is needed. However, the adjustment mechanism in the existing adjustable curtain horizontal adjustment device is directly installed on the end of the curtain rod, which occupies more space. In addition, when it comes to narrow installation areas such as corners, the installation cannot be embodied or the shading area is insufficient (as shown in FIG. 5 of the specification). Patents CN205605070U and U.S. Pat. No. 16,752,185 disclose a level regulator and a leveler for a window covering respectively, and the adjustment mechanisms of the two patents are arranged at the end of the curtain rod.

### SUMMARY OF THE DISCLOSURE

The technical problem to be solved by the present disclosure is to provide a horizontal adjustment device for a curtain and an electric curtain for the defects of the prior art.

The technical solution adopted by the present disclosure to solve the technical problems is as follows.

A horizontal adjustment device for a curtain is provided, including a reel and an adjustment mechanism for adjusting a height of the reel. A side of the adjustment mechanism is provided with a fixed installation piece for the reel to be installed, and the adjustment mechanism is disposed between the reel and a side on a window side.

In preferred embodiments, the adjustment mechanism includes a reel bracket and an installation bracket for installing to a wall surface. The reel bracket is disposed on a side of the installation bracket away from the wall through a guiding and sliding mechanism, a bottom of the installation bracket is provided with a first limiting plate, a bottom of the reel bracket is provided with an adjustment plate, the first limiting plate is disposed below the adjustment plate, the first limiting plate is connected to the adjustment plate through a detachable connecting member, the adjustment plate and the first limiting plate are provided with an adjustment device for adjusting a height of the adjustment plate relative to the first limiting plate, and a side of the reel bracket is provided with the fixed installation piece.

In preferred embodiments, the adjustment device includes an adjustment through hole arranged on the first limiting plate, and an adjustment stud arranged in the adjustment through hole.

In preferred embodiments, a positioning top block is provided on a top of the adjustment stud, and a positioning hole corresponding to the positioning top block is provided on the adjustment plate.

In preferred embodiments, the installation bracket is detachably connected to the wall, an installation through groove is provided in a middle of the installation bracket, and an installation screw that is threadedly connected to a threaded hole on the wall passes through the installation through groove.

In preferred embodiments, a hollow-out structure corresponding to the installation screw is provided in a middle of the reel bracket, and the hollow-out structure is configured to prevent the reel bracket from colliding with the installation screw.

In preferred embodiments, a top of the installation bracket is provided with a second limiting plate for limiting the reel bracket.

In preferred embodiments, the guiding and sliding mechanism includes an installation rib arranged on each of left and right sides of the installation bracket, and the installation rib is provided with a guiding and sliding groove for a sliding connection between the reel bracket and the installation bracket.

In preferred embodiments, the detachable connecting member includes two threaded through holes respectively provided on the first limiting plate and the adjustment plate, and a threaded post for connecting the two threaded through holes.

An electric curtain is provided, including a curtain and a horizontal adjustment device for curtain. Two horizontal adjustment devices for the curtain are provided and each of the installation brackets on the two horizontal adjustment devices is both provided with a rotating shaft. Any one of the two rotating shafts is connected to a reel motor for driving the reel to rotate, another one of the two rotating shafts is connected to the reel, and the curtain is rolled up on the reel.

The beneficial effect of the present disclosure is as follows. When the height of the reel needs to be adjusted, the end of the reel is installed on the fixed installation piece, and the height of the reel can be adjusted through the adjustment mechanism. When it comes to narrow installation areas such as corners, the fixed installation piece is arranged on one side of the adjustment mechanism, and the fixed installation piece is thinner, so that there will be no insufficient shading area under the adjustment mechanism. In addition, the adjustment mechanism is arranged between the reel and the wall on the same side as the window, so that the adjustment mechanism will be covered by the curtain fabric, and the aesthetics will not be affected.

### BRIEF DESCRIPTION OF THE DRAWINGS

In order to more clearly illustrate the embodiments of the present disclosure or the technical solutions in the prior art, the present disclosure will be further described below in conjunction with the drawings and embodiments. The drawings in the following description are only part of the embodiments of the present disclosure. Ordinary technicians can also obtain other drawings based on these drawings without paying creative work.

FIG. 1 is a schematic exploded diagram of an installation bracket and a reel bracket of a horizontal adjustment device for a curtain according to a preferred embodiment of the present disclosure;

FIG. 2 is a schematic overall diagram of the installation bracket and the reel bracket of the horizontal adjustment device for the curtain according to a preferred embodiment of the present disclosure;

FIG. 3 is a schematic overall exploded view of the horizontal adjustment device for the curtain according to a preferred embodiment of the present disclosure;

FIG. 4 is a schematic partially exploded diagram of the horizontal adjustment device for the curtain according to a preferred embodiment of the present disclosure;

FIG. 5 is a schematic diagram of insufficient light-shielding area in the prior art when it comes to a narrow installation area such as a wall corner; and

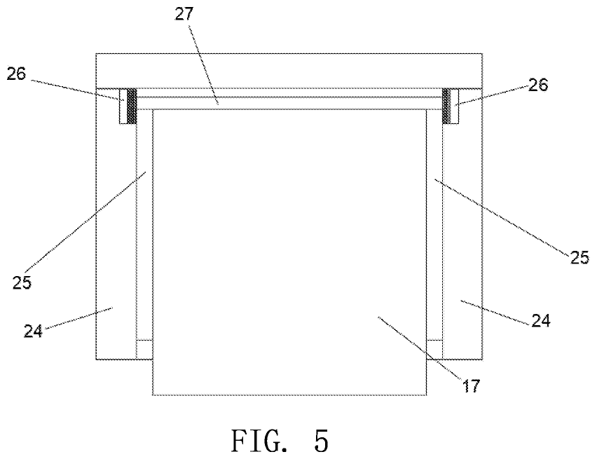

FIG. 6 is schematic diagram of a deviation of a curtain fabric when a curtain box or a bracket of the prior art is not horizontal.

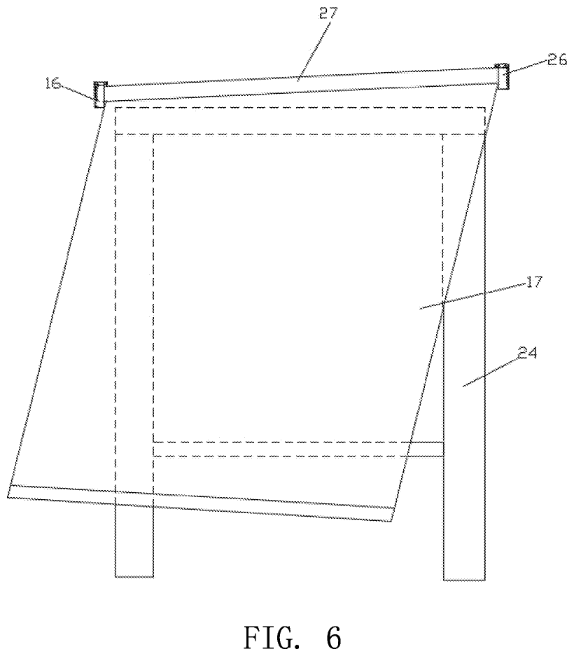

Reference numeral: 1, installation screw, 2, reel bracket; 3, installation bracket; 4, installation through groove; 5, installation rib; 6, adjustment plate; 7, threaded post; 8, first limiting plate; 10, adjusting stud; 11, fixed installation piece; 12, hollow-out structure; 13, second limiting plate; 14, threaded through hole; 16, reel; 17, curtain; 19, reel motor; 20, positioning top block; 21, positioning hole; 22, adjusting through hole; 23, rotating shaft; 24, wall; 25, incomplete shading; 26, adjustment mechanism; 27, curtain rod.

### DETAILED DESCRIPTION OF THE EXEMPLARY EMBODIMENTS

In order to make the purpose, technical solutions and advantages of the embodiments of the present disclosure more clear, the following will give a clear and complete description in conjunction with the technical solutions in the embodiments of the present disclosure. Apparently, the described embodiments are some, but not all, embodiments of the present disclosure. Based on the embodiments of the present disclosure, all other embodiments obtained by persons of ordinary skill in the art without making creative efforts belong to the protection scope of the present disclosure.

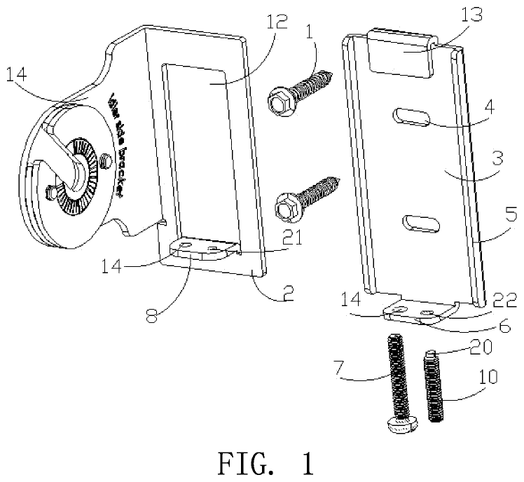

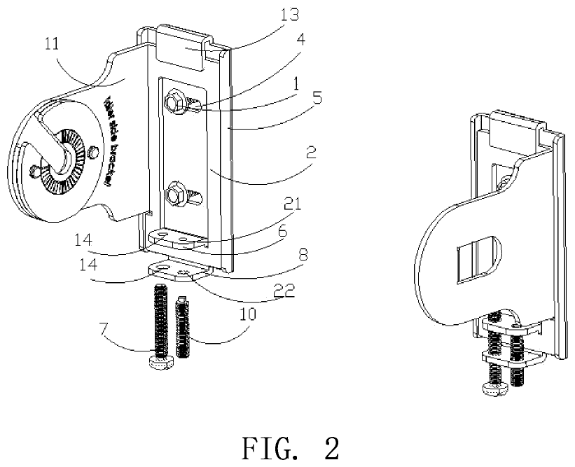

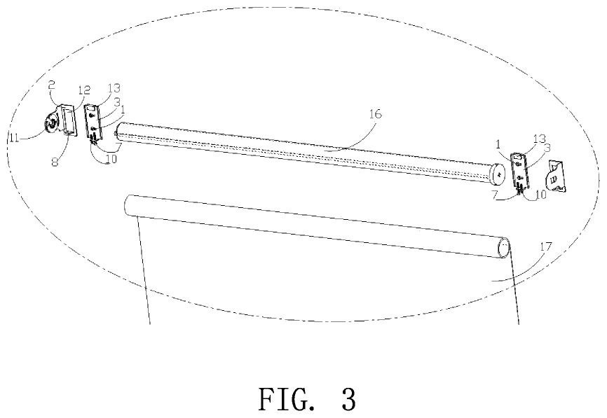

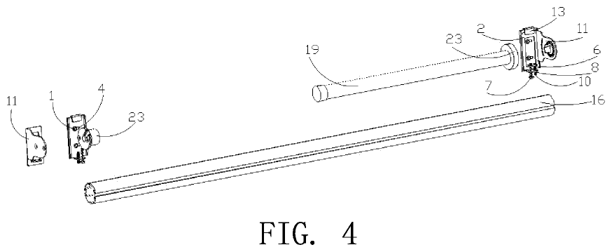

As shown in FIG. 1 to FIG. 4, a horizontal adjustment device for a curtain according to a preferred embodiment of the present disclosure includes a reel 16 and an adjustment mechanism for adjusting a height of the reel 16. One side of the adjustment mechanism is provided with a fixed installation piece 11 for the reel 16 to be installed, and the adjustment mechanism is arranged between the reel 16 and a wall on a window side.

When the height of the reel 16 needs to be adjusted, the end of the reel 16 is installed on the fixed installation piece 11, and the height of the reel 16 can be adjusted by the adjustment mechanism. When it comes to a narrow installation area such as a corner, the fixed installation piece 11 is arranged on a side with the adjustment mechanism, and the fixed installation piece 11 is relatively thin, so that there will be no insufficient light-shielding area under the adjustment mechanism. In addition, the adjustment mechanism is arranged between the reel and the wall on the same side as the window, so that the adjustment mechanism will be covered by the curtain fabric, and the aesthetics will not be affected.

As shown in FIG. 1 to FIG. 4, the adjustment mechanism includes a reel bracket 2 and an installation bracket 3 for installing to a wall surface. The reel bracket 2 is arranged on a side of the installation bracket 3 away from the wall through a guiding and sliding mechanism. A bottom of the installation bracket 3 is provided with a first limiting plate 8, a bottom of the reel bracket 2 is provided with an adjustment plate 6, and the first limiting plate 8 is disposed below the adjustment plate 6. The first limiting plate 8 is connected to the adjustment plate 6 through a detachable connecting member. Each of the adjustment plate 6 and the first limiting plate 8 is provided with an adjustment device for adjusting a height of the adjustment plate 6 relative to the first limiting plate 8, and a side of the reel bracket 2 is provided with the fixed installation piece 11.

The installation bracket 3 can be connected to the wall in a detachable connection manner, and can also be fixed to the wall in a fixed manner. The fixed manner can include nailing the installation bracket 3 to the wall through spikes, and can also include gluing the installation bracket 3 to the wall with fixing glue. When it is necessary to adjust the height of the reel 16, the detachable connecting member is detached, and an adjusting stud 10 is pressed against the adjustment plate 6. Then, an upward thrust can be applied to the adjustment plate 6 by mobilizing the adjustment device so that the reel bracket 2 can be pushed upward through a guiding and sliding mechanism for adjustment. After the adjustment is completed, the detachable connecting member is reassembled to reconnect the adjustment plate 6 to the first limiting plate 8. When it is necessary to lower the reel 16, the detachable connecting member is detached, and the adjustment stud 10 is pressed against the adjustment plate 6. Then, the adjustment device is mobilized to enable the reel bracket 2 to slide downward through the guiding and sliding mechanism so as to complete the adjustment. After the adjustment is completed, the detachable connecting member is reassembled to reconnect the adjustment plate 6 to the first limiting plate 8. When the present disclosure is applied in narrow places such as corners, the installation bracket 3 and the reel bracket 2 are arranged between the reel 16 and the wall so that the installation bracket 3 and the reel bracket 2 are on a back of the curtain, which will not affect the aesthetics of the curtain. A side of the reel bracket 2 where is bent is provided with the fixed installation piece 11, and a curtain rod is installed on the fixed installation piece 11, thereby ensuring that no shading dead angle will occur under the installation bracket 3 and the reel bracket 2.

As shown in FIG. 1 to FIG. 4, the adjustment device includes an adjustment through hole 5 arranged on the first limiting plate 8, and an adjustment screw 10 arranged in the adjustment through hole 5.

When it is necessary to adjust the height of the reel 16, the adjustment stud 10 can be rotated, the adjustment through hole 22 is threadedly engaged with the adjustment stud 10, and the adjustment stud 10 is pressed against the adjustment plate 6 and an upward thrust is applied to the adjustment plate 6 to adjust the height of the reel 16. When the reel 16 needs to be lowered, the adjustment stud 10 is rotated, the adjustment through hole 22 is threadedly engaged with the adjustment stud 10, the adjustment stud 10 moves downward, and the reel bracket 2 slides downward through the guide slide mechanism along with the downward movement of the adjustment stud 10 to complete the lowering of the reel 16.

As shown in FIG. 1 to FIG. 4, a top of the adjustment stud 10 is provided with a positioning top block 20, and the adjustment plate 6 is provided with a positioning hole 21 corresponding to the positioning top block 20.

When adjusting the reel 16, a stability of the adjustment can be ensured by engaging the positioning top block 20 of the adjustment stud 10 with the positioning hole 21, and a diameter of the positioning top block 20 is smaller than a diameter of the adjustment stud 10.

As shown in FIG. 1 to FIG. 4, the installation bracket 3 is detachably connected to the wall, a middle of the installation bracket 3 is provided with an installation through groove 4, and an installation screw 1 that is threadedly connected to a threaded hole on the wall passes through the installation through groove 4.

When installing, the threaded hole is provided on the wall, the installation screw 1 passes through the installation through groove 4, and the installation screw 1 is threadedly connected to the threaded hole on a cavity to fix the installation bracket 3. Multiple installation through grooves 4 and multiple installation screws 1 can be correspondingly provided, and a gasket can be disposed on a nut bottom of the installation through groove 4 for stable connection. The installation screw 1 can be a self-tapping screw.

As shown in FIG. 1 to FIG. 4, a hollow-out structure 12 corresponding to the installation screw 1 is provided in a middle of the reel bracket 2, and the hollow-out structure 12 is used to prevent the reel bracket 2 from colliding with the installation screw 1.

When adjusting the height of the reel bracket 2, the hollow-out structure 12 provided in the middle of the reel bracket 2 can prevent the reel bracket 2 from colliding with the hollow-out structure 12 during the adjustment to cause damage to the reel bracket 2 and the installation bracket 3.

As shown in FIG. 1 to FIG. 4, the top of the installation bracket 3 is provided with a second limiting plate 13 for limiting the reel bracket 2.

When the horizontal adjustment device for the curtain of the present disclosure is applied, the top of the installation bracket 3 is provided with the second limiting plate 13 that can be used to limit the reel bracket 2 and prevent the reel bracket 2 from moving upwards. The first limiting plate 8 and the second limiting plate 13 are integrally formed with the installation bracket 3 and made by a bending process, and the adjustment plate 6 and the reel bracket 2 are integrally formed and made by the bending process.

As shown in FIG. 1 to FIG. 4, the guiding and sliding mechanism includes an installation rib 5 arranged on each of left and right sides of the installation bracket 3, and the installation rib 5 is provided with a guiding and sliding groove for a sliding connection between the reel bracket 2 and the installation bracket 3.

When adjusting the reel 16, each of the left and right sides of the installation bracket 3 are provided with the installation rib 5, the installation rib 5 is provided with the guiding and sliding groove, and the reel bracket 2 slides up and down on the installation bracket 3 through the guiding and sliding groove.

As shown in FIG. 1 to FIG. 4, the detachable connecting member includes two threaded through holes 14 respectively provided on the first limiting plate 8 and the adjustment plate 6, and a threaded post 7 for connecting the two threaded through holes 14.

The detachable connection manner also includes a snap connection and a hinge connection.

As shown in FIG. 1 to FIG. 4, in a preferred embodiment according to the present disclosure, two horizontal adjustment devices for the curtain are provided, and each of the installation brackets 3 on the two horizontal adjustment devices is provided with a rotating shaft 23. Any one of the two rotating shafts 23 is connected to a reel motor 19 for driving the reel 16 to rotate, another one of the two rotating shafts 23 is connected to the reel 16, and a curtain 17 is rolled up on the reel 16.

When the electric curtain is used, any one of the two rotating shafts 23 is connected to the reel motor 19, another one of the two rotating shafts 23 is connected to the reel 16, and the rotating shaft motor 19 starts to drive the reel 16 to rotate, thereby retracting the curtain 17.

It should be understood that those skilled in the art can make improvements or changes based on the above description, and all these improvements and changes should belong to the protection scope of the appended claims of the present disclosure.

What is claimed is:

1. A horizontal adjustment device for a curtain, comprising a reel (16) and an adjustment mechanism for adjusting a height of the reel (16), wherein a side of the adjustment mechanism is provided with a fixed installation piece (11) for the reel (16) to be installed, and the adjustment mechanism is disposed between the reel (16) and a wall on a window side.

2. The horizontal adjustment device for the curtain according to claim 1, wherein the adjustment mechanism includes a reel bracket (2) and an installation bracket (3) for installing to a wall surface, the reel bracket (2) is disposed on a side of the installation bracket (3) away from the wall through a guiding and sliding mechanism, a bottom of the installation bracket (3) is provided with a first limiting plate (8), a bottom of the reel bracket (2) is provided with an adjustment plate (6), the first limiting plate (8) is disposed below the adjustment plate (6), the first limiting plate (8) is connected to the adjustment plate (6) through a detachable connecting member, the adjustment plate (6) and the first limiting plate (8) are provided with an adjustment device for adjusting a height of the adjustment plate (6) relative to the first limiting plate (8), and a side of the reel bracket (2) is provided with the fixed installation piece (11).

3. The horizontal adjustment device for the curtain according to claim 2, wherein the adjustment device includes an adjustment through hole (22) arranged on the first limiting plate (8), and an adjustment stud (10) arranged in the adjustment through hole (22).

4. The horizontal adjustment device for the curtain according to claim 3, wherein a positioning top block (20) is provided on a top of the adjustment stud (10), and a positioning hole (21) corresponding to the positioning top block (20) is provided on the adjustment plate (6).

5. The horizontal adjustment device for the curtain according to claim 2, wherein the installation bracket (3) is detachably connected to the wall, an installation through groove (4) is provided in a middle of the installation bracket (3), and an installation screw (1) that is threadedly connected to a threaded hole on the wall passes through the installation through groove (4).

6. The horizontal adjustment device for the curtain according to claim 5, wherein a hollow-out structure (12) corresponding to the installation screw (1) is provided in a middle of the reel bracket (2), and the hollow-out structure (12) is configured to prevent the reel bracket (2) from colliding with the installation screw (1).

7. The horizontal adjustment device for the curtain according to claim 2, wherein a top of the installation bracket (3) is provided with a second limiting plate (13) for limiting the reel bracket (2).

8. The horizontal adjustment device for the curtain according to claim 2, wherein the guiding and sliding mechanism includes an installation rib (5) arranged on each of left and right sides of the installation bracket (3), and the installation rib (5) is provided with a guiding and sliding groove for a sliding connection between the reel bracket (2) and the installation bracket (3).

9. The horizontal adjustment device for the curtain according to claim 2, wherein the detachable connecting member includes two threaded through holes (14) respectively provided on the first limiting plate (8) and the adjustment plate (6), and a threaded post (7) for connecting the two threaded through holes (14).

10. An electric curtain including the horizontal adjustment device for the curtain as claimed in claim 1, wherein two horizontal adjustment devices for the curtain are provided, and each of the installation brackets (3) on the two horizontal adjustment devices is provided with a rotating shaft (23); and
any one of the two rotating shafts (23) is connected to a reel motor (19) for driving the reel (16) to rotate, another one of the two rotating shafts (23) is connected to the reel (16), and the curtain is rolled up on the reel (16).

11. The electric curtain according to claim 10, wherein the adjustment mechanism includes a reel bracket (2) and an installation bracket (3) for installing to a wall surface, the reel bracket (2) is disposed on a side of the installation bracket (3) away from the wall through a guiding and sliding mechanism, a bottom of the installation bracket (3) is provided with a first limiting plate (8), a bottom of the reel bracket (2) is provided with an adjustment plate (6), the first limiting plate (8) is disposed below the adjustment plate (6), the first limiting plate (8) is connected to the adjustment plate (6) through a detachable connecting member, the adjustment plate (6) and the first limiting plate (8) are provided with an adjustment device for adjusting a height of the adjustment plate (6) relative to the first limiting plate (8), and a side of the reel bracket (2) is provided with the fixed installation piece (11).

12. The electric curtain according to claim 11, wherein the adjustment device includes an adjustment through hole (22) arranged on the first limiting plate (8), and an adjustment stud (10) arranged in the adjustment through hole (22).

13. The electric curtain according to claim 12, wherein a positioning top block (20) is provided on a top of the adjustment stud (10), and a positioning hole (21) corresponding to the positioning top block (20) is provided on the adjustment plate (6).

14. The electric curtain according to claim 11, wherein the installation bracket (3) is detachably connected to the wall, an installation through groove (4) is provided in a middle of the installation bracket (3), and an installation screw (1) that is threadedly connected to a threaded hole on the wall passes through the installation through groove (4).

15. The electric curtain according to claim 14, wherein a hollow-out structure (12) corresponding to the installation screw (1) is provided in a middle of the reel bracket (2), and the hollow-out structure (12) is configured to prevent the reel bracket (2) from colliding with the installation screw (1).
